(19) United States
(12) Patent Application Publication
(10) Pub. No.: US 2014/0240640 A1
(43) Pub. Date: Aug. 28, 2014

(54) HIGH EFFICIENCY POLARIZED AND COLLIMATED BACKLIGHT

(71) Applicant: SHARP KABUSHIKI KAISHA, Osaka-shi (JP)

(72) Inventors: Peter J. Roberts, Oxford (GB); David J. Montgomery, Oxfordshire (GB); James R. Suckling, Surrey (GB)

(73) Assignee: SHARP KABUSHIKI KAISHA, Osaka-shi (JP)

(21) Appl. No.: 13/778,610

(22) Filed: Feb. 27, 2013

(51) Int. Cl. F21V 8/00

(52) U.S. Cl. CPC G02B 6/0035
USPC 349/62; 362/607

(57) ABSTRACT

A thin collimated backlight is provided for use in a monochrome liquid crystal display or a color liquid crystal display with color converting elements. The color converting elements are located on the opposite side of the liquid crystal panel to the backlight. The backlight is illuminated by narrow-band light sources such as single color LEDs. The backlight is formed by a lightguide, one or more conventional light controlling sheets and a polymeric filter sheet. The polymeric filter acts to: 1) reflect one polarization direction over the bandwidth of source at all angles of incidence and 2) reflect the orthogonal polarization direction over the bandwidth of the source only at high incident angles. Light in this orthogonal polarization passes through the filter when incident close to the normal to the filter sheet. Light reflected by the filter is efficiently recycled within the backlight.

### TECHNICAL FIELD

The present invention relates to a backlight, for example for use with an at least partially transmissive spatial light modulator. The present invention also relates to a display including such a backlight.

In particular, the invention relates to a thin and collimated backlight for use with monochrome displays or displays in which phosphors are used for color conversion.

### BACKGROUND ART

U.S. Pat. No. 5,882,774 (James M. Jonza et. al, 3M, 10 Mar. 1995) discloses birefringent multilayer optical films in which the refractive indices in the thickness direction of adjacent layers are such that the Brewster angle is very large or nonexistent. This allows for multilayer film mirrors with high reflectivity for both planes of polarization for any incident direction. It also enables reflective polarizers with high reflectivity of the selected polarization direction for all incident directions. These properties can be maintained over a wide wavelength bandwidth.

WO 2010/059566 A1 (Michael F. Webber et. al., 3M, 19 Nov. 2008) discloses birefringent multilayer optical films which have reflectivity for normally incident light in an extended wavelength band of at least 75% for any polarization. The films have increased transmission for p-polarized light in the extended wavelength range in one plane of incidence at an angle θ₁. P-polarized light incident on the film in a second plane of incidence orthogonal to the first one is subject to a reflectivity of at least 75% at any incident angle.

WO 2010/059568 A1 (Michael F. Webber et. al., 3M, 19 Nov. 2008) discloses a reflective film tailored to give a reflectivity for p-polarized light incident in one plane that decreases by at least 50% from its normal incidence value at an incident angle θ₁. In a second plane, at the angle θ₁, the reflectivity remains higher.

WO 2010/059579 A1 (Michael F. Webber et. al., 3M, 19 Nov. 2008) discloses a reflective film with angularly dependent polarizing properties. P-polarized light in one plane of incidence is substantially reflected at near-normal angles, but it substantially transmitted at an oblique angle.

### SUMMARY OF INVENTION

According to an aspect of the invention an edge-lit lightguide based backlight is provided that emits collimated light substantially in a single polarization mode. These output characteristics are enabled by a specific form of reflective filter layer added to the backlight construction. The filter transmits only light with the desired characteristics, the remaining light being reflected and largely recycled within the backlight. The light re-cycling efficiency is improved by employing an efficient broad angle reflector beneath the lightguide and/or the inclusion of one or more diffuser sheets. All layers that are incorporated within the backlight construction show low absorption loss.

The enabling filter is based on stacked layers of two or more polymer materials. At least one of these materials is rendered optically anisotropic after a stretching procedure is applied. Preferentially, the filter is formed from bonding together two constituent multi-layer films. A uniaxial stretch is applied to each constituent film. Prior to bonding, the films are oriented such that the stretch axis direction of one constituent film is approximately orthogonal to the stretch axis direction of the other constituent film. The thicknesses of the layers within each constituent film after stretching are carefully chosen to give the required optical characteristics of the composite filter. The required thicknesses of each layer in the composite filter depend on the principle refractive index values of the layers after the stretching procedure.

The wavelength bandwidth over which such polymeric filters can provide collimated output as well as polarization selection is limited to less than around 100 nm if within the visible range. Thus, a single filter will not collimate a broadband white light source. The main embodiments of the invention pertain to narrow band collimated backlights. Such backlights are appropriate for use in phosphor luminescent displays (PLDs) and monochrome displays.

In a PLD, pixel color is produced by wavelength conversion in a patterned array of phosphor materials. Each phosphor element in the array is registered with a TFT sub-pixel aperture. A PLD in which the phosphor array is located above the liquid crystal panel, that is to say on the opposite side of the panel from the backlight, is of particular interest since its viewing properties are similar to those offered by OLED. Specifically, the weak luminance and color variation with angle enable an ultra-wide viewing angular range. For such displays, a collimated blue or UV backlight is needed to avoid incorrectly registered phosphors being excited (cross talk).

Both monochrome liquid crystal displays (LCDs) and PLDs can benefit from a collimated backlight since: 1) the light traversing the liquid crystal cell is close to being on-axis, thus improving contrast; 2) it enables light to be focused through thin film transistor (TFT) apertures so that device efficiency is improved and contrast is further enhanced due to reduced scatter from the electronics. For a monochromatic LCD, to ensure that the viewing angle range is sufficiently broad, it may be necessary to add a diffuser sheet above the liquid crystal cell and polarizers.

According to one aspect of the invention, a backlight includes: a lightguide having a light receiving face for receiving light emitted by a light source, a first major face and a second major face; extraction features arranged relative to the lightguide, the extraction features configured to extract light from the second major face; and a filter including a first multilayer birefringent polymeric film arranged on a side of the lightguide corresponding to the second major face, wherein over at least a portion of a bandwidth of the light source the first multilayer birefringent polymeric film reflects light in one polarization state at substantially all angles of incidence, reflects light in another polarization state only at angles of incidence greater than a predetermined threshold, and transmits a majority of light that is not reflected by the first multilayer birefringent polymeric film as collimated light.

According to one aspect of the invention, a reflector arranged on a side of the lightguide corresponding to the first major face.

According to one aspect of the invention, the backlight includes a plurality of narrow band light sources arranged relative to the light receiving face so as provide light to the lightguide.

According to one aspect of the invention, the plurality of narrowband light sources comprise light emitting diodes (LEDs).

According to one aspect of the invention, the backlight includes at least one light controlling layer.

According to one aspect of the invention, at least one light controlling layer comprises a brightness enhancing film (BEF) or a diffuser sheet.

According to one aspect of the invention, the backlight includes at least one brightness enhancement film (BEF) arranged between the multilayer birefringent polymeric film and the second major face.

According to one aspect of the invention, the backlight includes a second multilayer birefringent polymeric film arranged on a side of the lightguide corresponding to the second major face, wherein the first and second multilayer birefringent polymeric films are configured to operate over different wavebands.

According to one aspect of the invention, the multilayer birefringent polymeric film comprises a first part and a second part adjacent to the first part, wherein the first part is configured to reflect a single polarization of light over at least part of a bandwidth of the light source, and the second part is configured to reflect an orthogonal polarization of light only at angles greater than a predetermined threshold relative to a normal of the face of the multilayer birefringent polymeric film that receives the light.

According to one aspect of the invention, the predetermined threshold is less than 40 degrees.

According to one aspect of the invention, the first part and the second part of the multilayer birefringent polymeric film each comprise a plurality of polymers.

According to one aspect of the invention, a first polymer of the plurality of polymers is birefringent, and a second polymer of the plurality of polymers is isotropic.

According to one aspect of the invention, the multilayer birefringent polymeric film comprises a first part and a second part adjacent to the first part, wherein each of the first part and the second part is configured to provide reflection of a single polarization state over a target angle and wavelength range.

According to one aspect of the invention, each of the first part and the second part is rendered anisotropic by an applied stretch, and the first and second parts are arranged such that a stretch direction of the first part is orthogonal to a stretch direction of the second part.

According to one aspect of the invention, the first multilayer birefringent polymeric film comprises more than two different types of polymers.

According to one aspect of the invention, a display device includes a liquid crystal panel, and a backlight as described herein.

According to one aspect of the invention, the display device is a monochrome display device or a phosphor luminescent display. To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 illustrates two conventional display forms that benefit from a polarizing and collimating backlight in accordance with the invention. FIG. 1(A) shows a monochrome display. FIG. 1(B) shows a display that utilizes a blue backlight with red and green color produced by color conversion phosphors.

FIG. 2 illustrates an exemplary backlight that gives collimated and polarized output.

FIG. 3 illustrates an exemplary backlight configuration in a preferred embodiment of the invention.

FIG. 4 illustrates alternative embodiments of a backlight in accordance with the invention. FIG. 4(A) shows an embodiment without BEF sheets. FIG. 4(B) shows an embodiment in which multiple filters are stacked together.

FIG. 5 illustrates a preferred embodiment of a filter component. FIG. 5(A) shows two constituent polymer films. FIG. 5(B) shows a composite filter film.

FIG. 6 shows an alternative configuration for the filter film. It is made from 3 or more constituent films with adjacent films in the construction having orthogonal directions for an applied stretch.

FIG. 7 shows an alternative configuration for a component of the filter film. The film contains three or more different types of polymer layer in its construction.

FIG. 8 shows the transmission response of an example filter film embodiment. FIG. 8(A) shows the transmission of y-polarized light FIG. 8(B) shows corresponding data for x-polarized light. FIG. 8(C) shows the region where the transmission of y-polarized light is greater than 50%. FIG. 8(D) shows corresponding data for x-polarized light. The plots also show the LED spectrum from a typical blue LED.

FIG. 9 shows the normalized light intensity distribution emitted from a backlight configuration that exemplifies the preferred embodiment of the invention. FIG. 9(A) shows the azimuthally averaged intensity distribution. FIG. 9(B) shows the fraction of backlight power within a cone of polar angle A. Also shown is the corresponding data for a backlight without the filter layer present.

### DESCRIPTION OF REFERENCE NUMERALS

1 refers to a collimated backlight with a narrow emission bandwidth.
2 refers to a lens array for focusing light from the backlight.
3 refers to the lower polarizer of a liquid crystal display panel.
3′ refers to the upper polarizer of a liquid crystal display panel.
4 refers to apertures in a TFT layer.
5 refers to a liquid crystal cell.
6 refers to apertures in a black mask.
7 refers to a diffuser layer above a liquid crystal panel
21R refers to a chamber registered with a red sub-pixel TFT aperture.
21G refers to a chamber registered with a green sub-pixel TFT aperture.
21B refers to a chamber registered with a blue sub-pixel TFT aperture.
22R refers to a black mask aperture registered with a red sub-pixel.
22G refers to a black mask aperture registered with a green sub-pixel.
22B refers to a black mask aperture registered with a blue sub-pixel.
30 refers to a lightguide.
30a refers to a light receiving face of the lightguide.
30b refers to a first major face of the lightguide.
30c refers to a second major face of the lightguide.
31 refers to a narrow band light source.
32 refers to lightguide extractions features.
33 refers to a reflector.
34 refers to a diffuser sheet.
35 refers to a first brightness enhancement film
35′ refers to a second brightness enhancement film
36 refers to a reflective polarizer film
37 refers to a band pass filter.
41 refers to a polymeric reflective filter giving angle and polarization selection
51 refers to a stacked arrangement of two or more polymeric reflective filters giving angle and polarization selection.

### DETAILED DESCRIPTION OF INVENTION

The present invention will now be described in detail with reference to the drawings, in which like reference numerals are used to refer to like elements throughout.

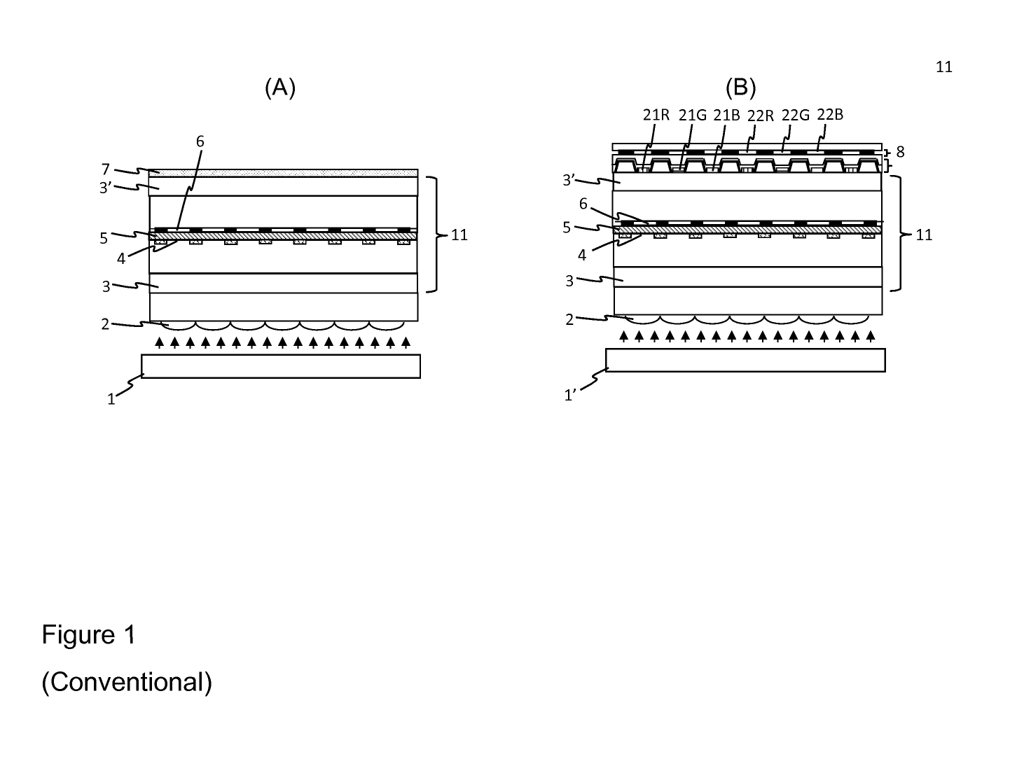

FIG. 1 shows two types of liquid crystal display (LCD) that involve relatively narrow-band light passing through the liquid crystal (LC) cell 5. The form shown in FIG. 1(A) is a monochrome display. Light from a monochrome backlight 1 is subjected to spatial modulation by transmission through a conventional liquid crystal panel 11 containing: a lower polarizer 3, an actively addressed TFT layer with apertures 4, an LC cell 5, a black-mask array with apertures 6 and an upper polarizer 3′. The efficiency of the display is impacted by absorption and scatter in the black-mask and TFT electronics. If light from the backlight 1 is collimated, a focusing lens sheet 2 can be used to increase the efficiency by focusing the light through the TFT apertures 4 and the black mask apertures 6. The associated reduction in scattering within the panel also leads to an increased contrast ratio (CR). The CR is further improved using a collimated backlight since the angular spread of light passing through the LC cell 5 and polarizers 3 and 3′ is reduced. A diffusing layer 7 can be placed above the LC panel 11 in order to increase the angular range over which the display may be viewed.

FIG. 1(B) shows a configuration that makes use of a blue backlight 1′. A liquid crystal panel 11 is again used to spatially modulate the light. Each pixel is now divided into three color sub-pixels. The light passing through the LC panel enters an array of chambers 21R, 21G, and 21B. Each chamber 21R is registered with a red sub-pixel aperture within the TFT. Similarly, each chamber 21G is registered with a green sub-pixel aperture and each chamber 21B with a blue sub-pixel aperture. If the backlight is sufficiently collimated, a lens sheet 2 may be used to focus the light through each aperture in the TFT and black-mask into the correctly addressed chamber 21R, 21G or 21B. Without collimation, some backlight light will pass through a TFT aperture and enter an incorrectly registered chamber. Such cross-talk processes degrade the displayed image. A red-emitting phosphor is housed in each chamber 21R, a green phosphor in each chamber 21G and diffusive material in each chamber 21B. The phosphors are chosen to give adequate absorption over the spectrum of the backlight. The red, green and blue light radiance distributions escaping from the front of the display panel, having emanated from all of the sub-pixel chambers 21R, 21G and 21B and passed through a black-mask with apertures 22R, 22G and 22B, constitute the viewable image. Color filters can be included at the apertures of the black mask in order to sharpen the displayed image. The blue backlight 1′ can be replaced by a UV backlight, in which case a blue emitting phosphor is housed in the chambers 21B instead of wavelength preserving scattering material.

It will be clear that both display forms described above greatly benefit from use of a collimated backlight with a relatively narrow emission wavelength range. In most display applications, the collimating backlight needs to be thin, efficient, offer good spatial uniformity and also be relatively cheap to produce. Conventional light-guide based backlights do not satisfy the collimation requirements. Direct-view backlights, for example based on an array of single-reflection LEDs (SRLEDs), can provide adequate collimation but are not sufficiently thin. In order to improve the collimation properties of a light-guide based backlight, a reflective filter can be added that reflects high angle light yet allows collimated light to pass through. High angle light is here defined to propagate at angles higher than a value θ_{c} relative to the normal to the backlight plane. The angle θ_{c} thus sets the required collimation level, with a typical value being θ_{c}=20°. The light reflected by the filter is recycled in the backlight. The efficiency of the recycling is set by losses in the various backlight layers as well as in the filter. A thin, low-loss reflective filter that allows only collimated light to transmit is not currently available for broad band light such as white light. For a narrower bandwidth, an interference band pass filter (BPF) can fulfill this function.

Preferentially, the collimation angle θ_{c}′ is in the range 10° to 30°.

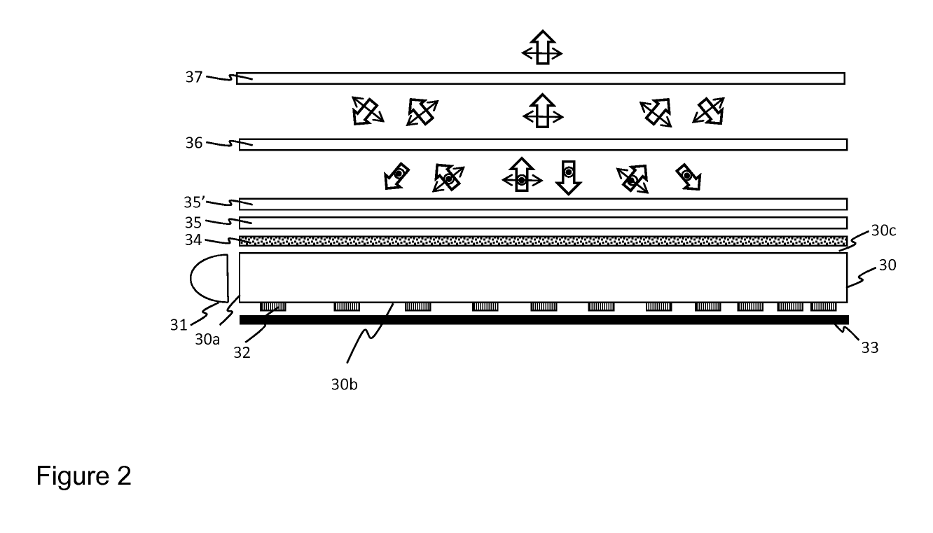

FIG. 2 shows a typical edge lit light-guide backlight geometry with an added BPF 37. The light sources 31 emit narrow band light. Preferentially, the bandwidth of the sources is below 100 nm. Light is ejected from the lightguide 30, which includes a light receiving face 30a, a first major face 30b and a second major face 30c, by means of extraction features 32. Any light that propagates downwards below the lightguide 30 is reflected in the reflector 33. A diffusive layer 34 above the lightguide 30 improves the spatial homogenization of the light and smoothens the luminance distribution. Brightness enhancement films (BEFs) 35 and 35′ provide some reflective angular filtering but some high angle light survives and is transmitted upwards from these layers (the diffusive layer and/or the BEFs may be considered light controlling layers). A reflective polarizing sheet (DBEF) 36 can be added to selectively transmit the polarization direction aligned with the pass direction of the lower polarizer of the TFT panel (not shown). The orthogonal polarization is largely reflected for recycling within the backlight. The BPF 37 is placed above the DBEF 36 in the example configuration shown in FIG. 2.

The BPF can be fabricated using known techniques. Various forms are possible, all involving multiple layers of at least two types of material. The layers may, for example, be deposited by sputtering. Typical constituent materials used in this process are TiO₂ and SiO₂ due to the relatively low loss and high refractive index contrast of these materials. The layers may alternatively be polymeric. A co-extrusion process may be used to deposit alternating layers of constituent polymers that give an adequate refractive index difference. The multilayer stack thus formed may be stretched to produce a filter with layer thicknesses and refractive index values that give rise to the targeted BPF characteristic.

An experimental investigation into light recycling processes within a conventional backlight with a BPF was undertaken. The studied geometry adheres to the form shown in FIG. 2 with blue GaN LEDs used as light sources. The BPF was formed from TiO₂ and SiO₂ layers and gives a long wavelength cut-off to transmission at around 455 nm. All light above this wavelength will not pass through the filter and is ultimately lost. Hence, only the recycling efficiency of light components below this wavelength was considered. The study showed that loss in the backlight layers severely restricts the recycling efficiency. Absorption in the DBEF 36 and BPF 37 was found to account for the majority of this loss. In order to improve light recycling and hence the backlight efficiency, the combined loss in these filters needs to be reduced.

A conventional DBEF is optimized to reflect one polarization over the entire visible spectrum. It does not provide significant angular filtering. The disclosed invention relies upon a polymeric filter that combines the roles of a reflective polarization filter and a reflective angular filter. The filter is designed to be effective over the relatively narrow bandwidth of a source such as a blue LED. Preferentially, the narrow bandwidth of the LED is less than 100 nm. The filter can give rise to less absorption loss per pass than a conventional DBEF despite its added angular filtering capability.

A backlight in accordance with the present invention emits collimated light in substantially a single polarization mode. The backlight can include a lightguide 30 having a light receiving face 30a for receiving light emitted by a light source, such as one or more narrow band light sources (e.g., one or more LEDs configured to emit narrow band light). The lightguide 30 further includes a first major face 30b and a second major face 30c, and extraction features 32 arranged relative to the lightguide and configured to extract light from the second major face 30c. A filter including multilayer birefringent polymeric film is arranged on a side of the lightguide corresponding to the second major face. The filter is configured such that, over at least a portion of a bandwidth of the light source, light is reflected in one polarization state with a reflection coefficient greater than 50% at all angles of incidence, yet reflects light in another polarization state with a reflection coefficient greater than 50% only at angles of incidence greater than a predetermined threshold θ_{c}′. The majority of light that is not reflected by the birefringent polymeric filter is transmitted as substantially collimated light.

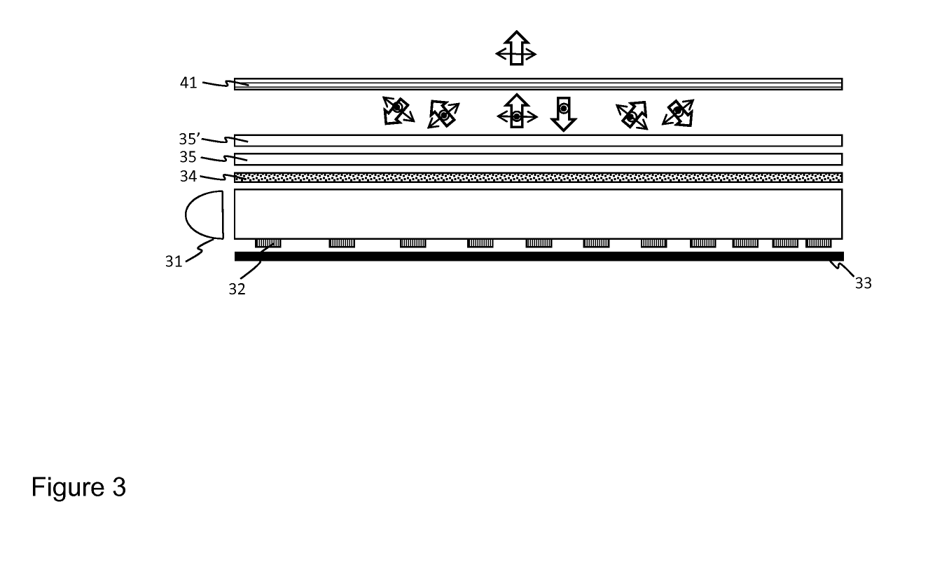

FIG. 3 schematically illustrates the operation of the filter in a lightguide-based backlight. The backlight layers are the same as described previously, except that the DBEF 36 and BPF 37 are replaced by the disclosed filter 41. Light in one polarization state is reflected for substantially all incident directions, with the reflection coefficient at all angles preferentially being larger than 50% over the wavelength bandwidth of the light source 31. Light in the orthogonal polarization direction is reflected, with a reflection greater than 50%, only for incident angles larger than a value θ_{c}′. The angle θ_{c}′ thus sets the chosen collimation level, a typical value for θ_{c}′ being 20°. A majority of light in this orthogonal polarization state incident at an angle less than θ_{c}′ to the normal to the plane of the filter passes through. The light reflected by filter is recycled in the backlight.

The nature of the bottom reflector 33 that reflects the majority of light reflected at the filter 41 influences the recycling efficiency. Preferentially, the filter 33 has a total reflectivity above 95% over the backlight bandwidth. The reflector 33, which may be arranged on a side of the lightguide corresponding to the first major face, may have a reflectivity above 98%. The reflector 33 may be a diffuse reflector. A diffuse reflecting characteristic can act to improve the recycling in propagation direction compared to a specular reflector.

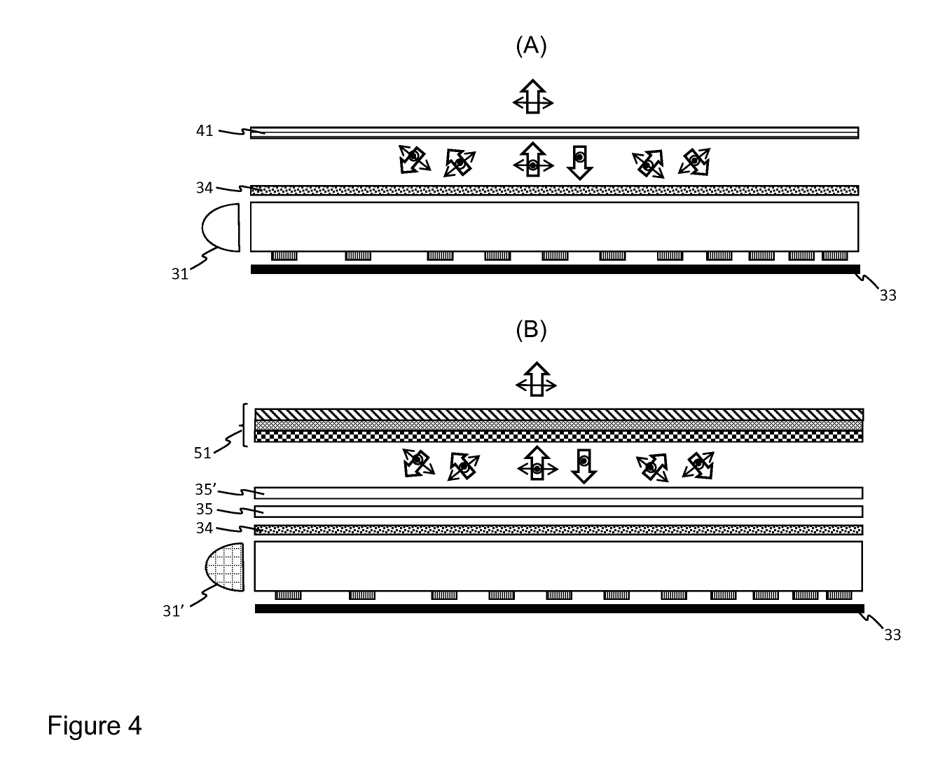

FIG. 4(A) shows a second embodiment of the invention. This configuration corresponds to removing the one or more BEF layers 35 and 35′ of the preferred embodiment shown in FIG. 3. The polarization/angle filter is fully relied upon to improve the collimation from the backlight. The absence of the BEF layers leads to a thinner and cheaper collimated backlight solution. The small sharp features protruding from the surface of BEF layers can become worn down, particularly if a touch panel exists above the liquid crystal display. Their removal can therefore lead to a more robust display.

FIG. 4(B) shows a third embodiment of the invention, where a second multilayer birefringent polymeric film is arranged on a side of the lightguide corresponding to the second major face, and the first and second multilayer birefringent polymeric films are configured to operate over different wavebands. More specifically, two or more polymeric films 51, that behave as combined angular and polarization filters, are placed above the backlight layers. Each one of the filters targets operation over distinct but overlapping wavebands. In this way, angle and polarization selection can be enhanced.

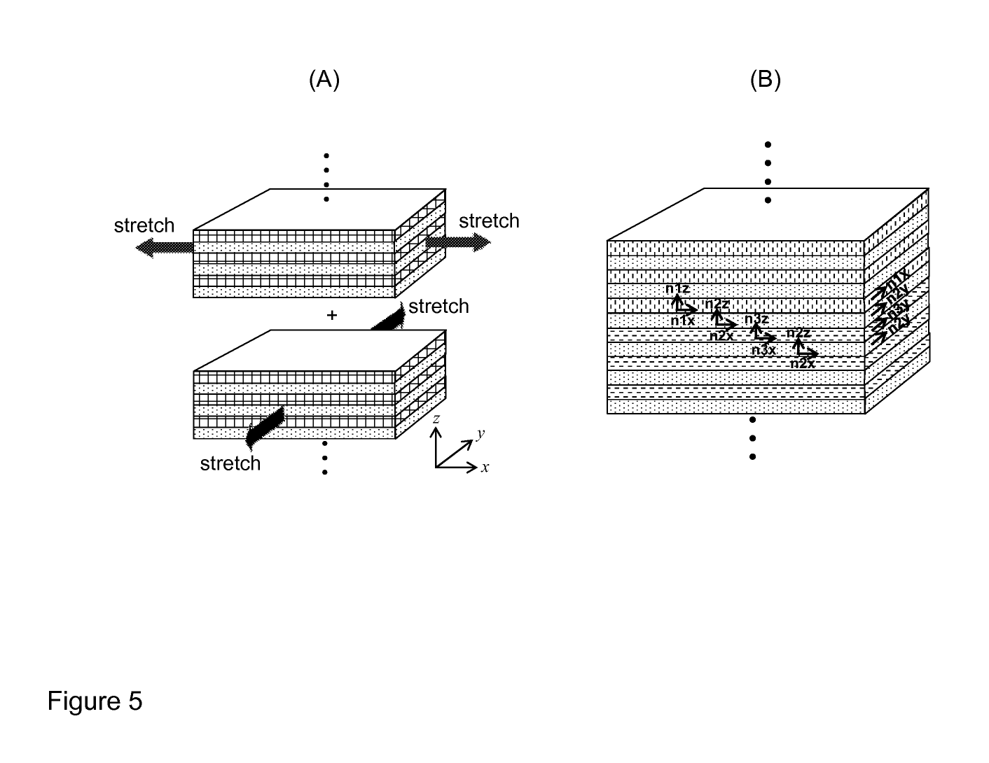

FIG. 5(A) schematically shows the construction of a preferred embodiment of the enabling filter. It is composed of two polymeric constituents (a first part and a second part). One of the constituents (a first part) reflects a single polarization over at least part of the bandwidth of the source illumination and all incident directions with a reflection coefficient greater than 50%. The second constituent (a second part), which may be arranged adjacent to the first part, reflects the orthogonal polarization with more than 50% efficiency only at incident angles greater than an angle θ_{c}′ that defines the collimation. Preferentially, the second constituent acts to reflect at least 80% of backlight light power in this polarization that is incident at angles larger than 40° relative to the normal to the surface of the film that receives the light as measured in air. The two constituents may be optically bonded together, using known techniques, to form a single composite filter. The resulting composite filter is shown schematically in FIG. 5(B).

Both of the constituent films may comprise a plurality of polymer layers. Each constituent may be formed using a co-extrusion process. In a preferred embodiment of the filter, shown in FIG. 5, each constituent film contains two types of polymer. Both constituents are separately subjected to a uniaxial stretch. After the stretch, a “type 1” polymer is rendered birefringent, whereas a “type 2” polymer remains largely isotropic. The polymers are chosen so that the principle refractive index values of the two layers are rendered similar after the stretching process except for along the stretch direction. Preferentially, the difference in refractive indices of the two layers is less than 0.02 except along the stretch direction. The two constituent films are oriented such that their stretch directions are orthogonal, as indicated in FIG. 5(A).

The thicknesses of the layers in each constituent film are carefully chosen to give the desired optical characteristics after the stretching processes have been applied. The number of layers required in each constituent depends on the source bandwidth, the principle refractive index values of the layers after stretching and the required rejection characteristics. A person having ordinary skill in the art would know how to choose the thickness to give a desired optical characteristic and how to select the number of layers based on the above-referenced characteristics.

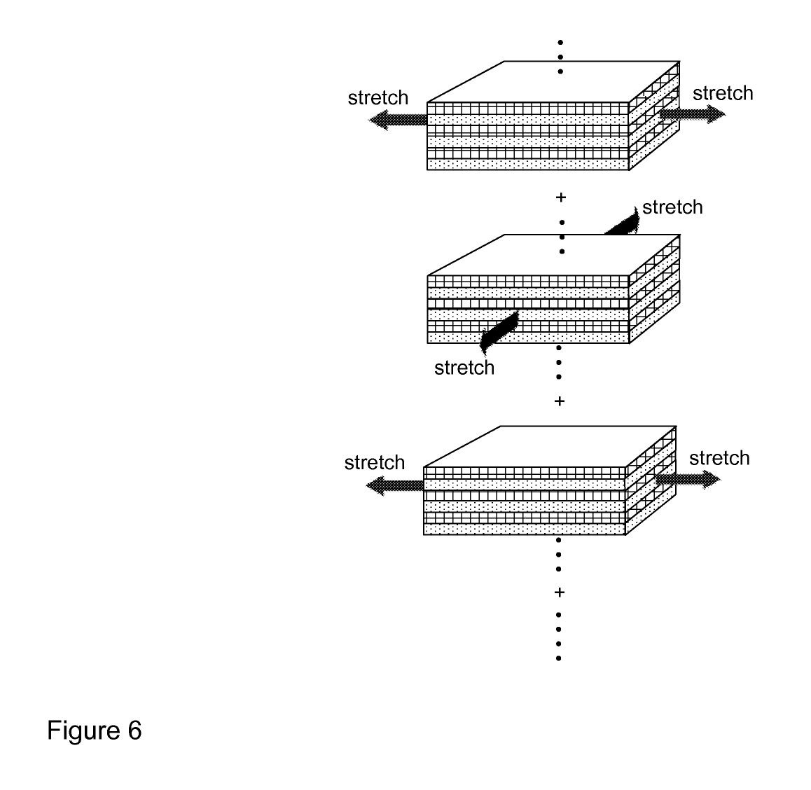

FIG. 6 shows an embodiment of a polymeric film that is composed of more than two separate constituent films (e.g., a first part, a second part adjacent to the first part, and a third part adjacent to the second part). Each constituent film provides reflection of a single polarization state over a target angle and wavelength range. Each constituent film is rendered anisotropic by an applied stretch. The constituents are ordered such that the stretch direction of each constituent is orthogonal to the stretch direction of neighboring constituents.

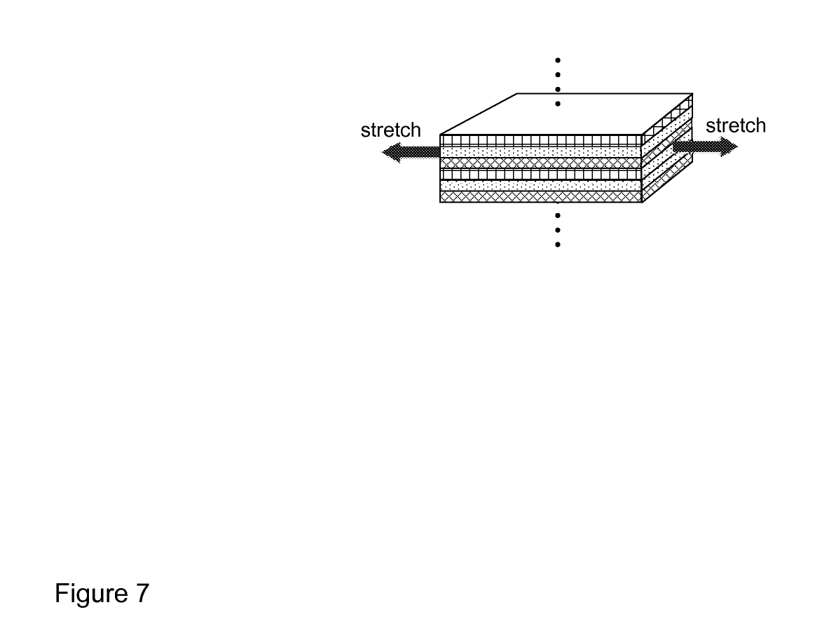

FIG. 7 shows a filter constituent that comprises a first multilayer birefringent film with more than two different types of polymer. After a stretch is applied, at least one of the constituent layers is rendered birefringent.

Simulations have been performed in order to assess the backlight performance that can be expected with the addition of the combined polarization and angular filter. First, a filter design was found that gives the desired optical performance. The optical characteristics of the filter are calculated using a 4×4 transfer matrix formulation that will be familiar to those skilled in the art. Second, the filter is included in a backlight simulation based on a ray-tracing method.

The filter design is based on two constituent films as shown in FIG. 5. Each constituent is based on quarter wave (QW) stacks. At the available index contrasts, the reflection band associated with a single QW stack is not broad enough to cover the target spectral and angular regions. A number of QW stacks are therefore concatenated together to cover the required range. The step in layer thicknesses between neighboring QW stacks is such that some overlap in their reflection bands occurs. This allows for a finite tolerance to the layer thickness and refractive indices in the fabricated filter. The principle reflective index values used for the example filter are given in the table below:

| n1x | n1y | n1z | n2x | n2y | n2z | n3x | n3y | n3z |
|---|---|---|---|---|---|---|---|---|
| 1.88 | 1.64 | 1.64 | 1.64 | 1.64 | 1.65 | 1.64 | 1.88 | 1.65 |

These values are typical for polymeric layers used in birefringent filters, as disclosed for example in U.S. Pat. No. 5,882,774 (James M. Jonza et. al, 3M, 10 Mar. 1995).

The lower constituent of the example filter contains a total of 252 material layers. The thicknesses of the layers in the QWs were chosen such that high reflection is maintained over the wavelength range of a typical blue GaN LED in the polarization direction with maximal projection along the x-direction (x-polarization). This reflection occurs for all angles of incidence from air. The orthogonal polarization (y-polarization) suffers little reflection from the film until close to grazing incidence is reached.

The second constituent film contains a total of 168 material layers. The layer thicknesses were chosen to give reflection of high angle y-polarized light over the bandwidth of a typical blue LED, yet allow most y-polarized light from this source to pass through when directed close to the normal to the filter plane. The x-polarized light largely passes through the second constituent film unless close to grazing incidence.

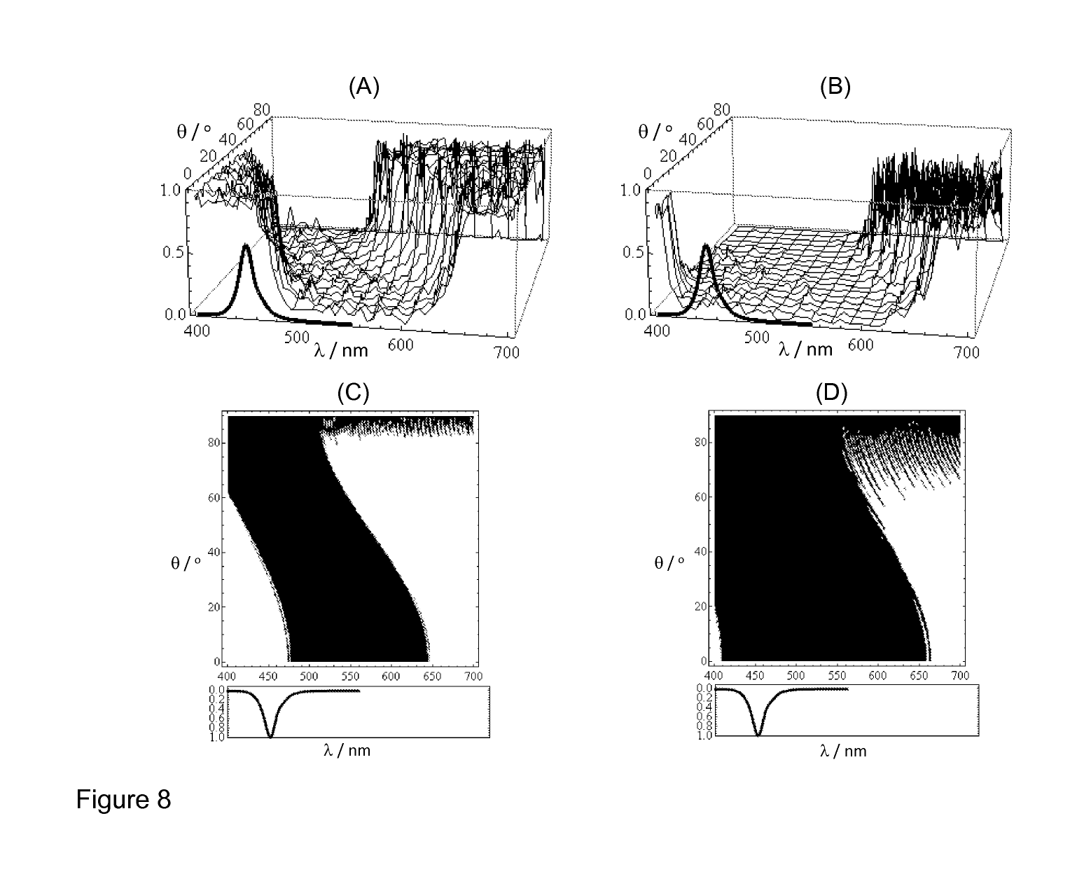

FIG. 8(A) shows the calculated transmission of the y-polarized state through the example polarization/angle filter. FIG. 8(B) shows corresponding data for the orthogonal polarization state. The spectrum from a typical blue LED is also shown in these figures. To make the regions of high and low transmission more clear, FIGS. 8(C) and 8(D) show in white regions where the transmission is above 50%, and in black regions where the transmission is below 50%. FIG. 8(C) gives this information for y-polarized light and FIG. 8(D) gives this information for x-polarized light. The typical blue LED spectrum is again shown for reference.

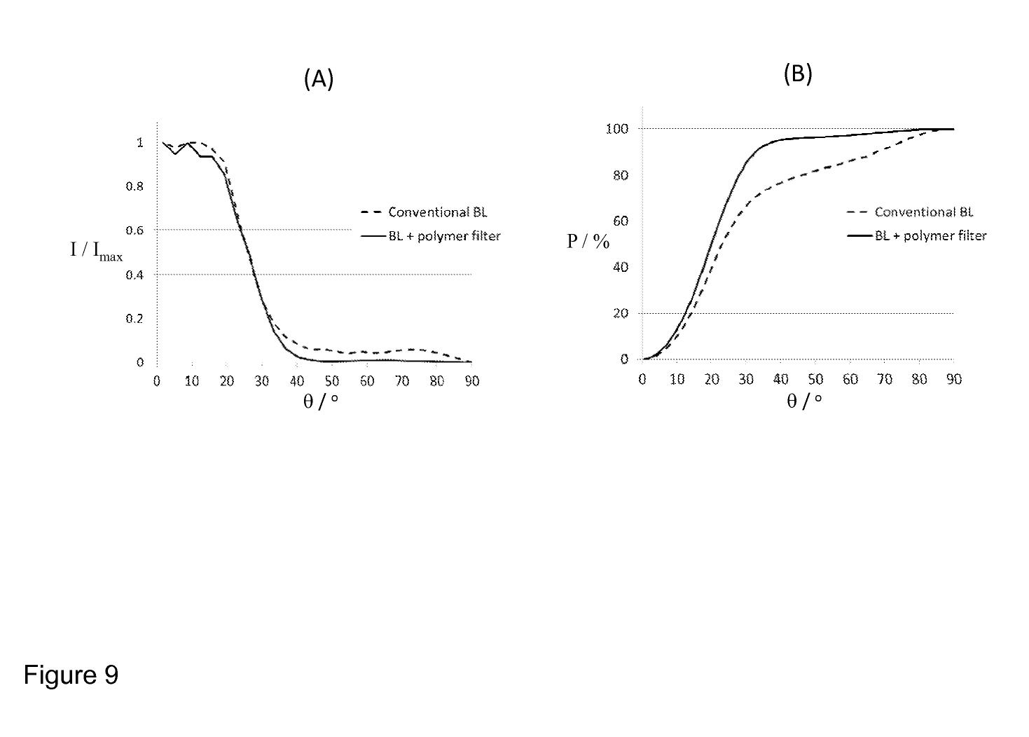

FIG. 9 presents data from a simulation of a backlight with the example combined polarization and angle filter included. The backlight is of the form shown in FIG. 3. A ray-tracing package was used for the simulation. FIG. 9(A) shows the normalized intensity distribution emitted by the backlight into air as a function of angle 8 relative to the backlight normal. The intensity distribution has been averaged over azimuthal angles. Also shown is the intensity distribution from the backlight without the filter present. It is confirmed that the intensity of high angle components have been heavily suppressed by the action of the filter. FIG. 9(B) shows the fraction of backlight power emitted into a cone of half-angle 8 centered at the normal to backlight. It is seen that, with the filter present, less than 5% of light power is emitted at angles above θ=40°. Without the filter present, this power fraction is around 25%.

The backlight efficiency was also found by simulation. The efficiency is defined as the fraction of the LED light power that passes through the lower polarizer 3 of the display. Absorption loss in the various layers of the backlight arrangement, as well as the filter, was included. With the example filter present, the efficiency was found to be 29.3%.

A model of a conventional reflective polarizer was also constructed. The polarizer reflects one polarization state over the visible waveband and all incident angles. The material properties of the layers used in its construction are the same as was used in the angle and polarization filter described above. The filter contains a total of 630 layers. A model of a conventional BPF, formed from TiO₂ and SiO₂ layers, was also built. This filter gives comparable angle selection to that of the example polymer filter. The example polymer filter was replaced by the polarization filter and BPF in the backlight model. The efficiency was found to have decreased to 20%. This confirms the advantage of using a combined polymeric polarization and angle filter that has been optimized for use over a selected wavelength range.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention pertains to a backlight that can be used in liquid crystal displays. In essence the invention relates to backlights that emit well collimated light substantially within a single polarization mode. The disclosed backlights are enabled by a particular form of birefringent polymeric interference filter. Other than for the addition of such a filter layer, the disclosed backlights are largely of a standard lightguide-based composition, enabling cheap construction. The disclosed backlights can be used in monochrome liquid crystal displays with improved contrast ratio. The disclosed backlights can be used to enable thin and efficient phosphor luminescent displays with high contrast ratio and low cross-talk.

1. A backlight, comprising:
a lightguide having a light receiving face for receiving light emitted by a light source, a first major face and a second major face;
extraction features arranged relative to the lightguide, the extraction features configured to extract light from the second major face; and
a filter including a first multilayer birefringent polymeric film arranged on a side of the lightguide corresponding to the second major face, wherein over at least a portion of a bandwidth of the light source the first multilayer birefringent polymeric film reflects light in one polarization state at substantially all angles of incidence, reflects light in another polarization state only at angles of incidence greater than a predetermined threshold, and transmits a majority of light that is not reflected by the first multilayer birefringent polymeric film as collimated light.

2. The backlight according to claim 1, comprising a reflector arranged on a side of the lightguide corresponding to the first major face.

3. The backlight according to claim 1, further comprising a plurality of narrow band light sources arranged relative to the light receiving face so as provide light to the lightguide.

4. The backlight according to claim 3, wherein the plurality of narrowband light sources comprise light emitting diodes (LEDs)

5. The backlight according to claim 1, further comprising at least one light controlling layer.

6. The backlight according to claim 5, wherein the at least one light controlling layer comprises a brightness enhancing film (BEF) or a diffuser sheet.

7. The backlight according to claim 1, comprising at least one brightness enhancement film (BEF) arranged between the multilayer birefringent polymeric film and the second major face.

8. The backlight according to claim 1, comprising a second multilayer birefringent polymeric film arranged on a side of the lightguide corresponding to the second major face, wherein the first and second multilayer birefringent polymeric films are configured to operate over different wavebands.

9. The backlight according to claim 1, wherein the multilayer birefringent polymeric film comprises a first part and a second part adjacent to the first part, wherein the first part is configured to reflect a single polarization of light over at least part of a bandwidth of the light source, and the second part is configured to reflect an orthogonal polarization of light only at angles greater than a predetermined threshold relative to a normal of the face of the multilayer birefringent polymeric film that receives the light.

10. The backlight according to claim 9, wherein the predetermined threshold is less than 40 degrees.

11. The backlight according to claim 9, wherein the first part and the second part of the multilayer birefringent polymeric film each comprise a plurality of polymers.

12. The backlight according to claim 11, wherein a first polymer of the plurality of polymers is birefringent, and a second polymer of the plurality of polymers is isotropic.

13. The backlight according to claim 1, wherein the multilayer birefringent polymeric film comprises a first part and a second part adjacent to the first part, wherein each of the first part and the second part is configured to provide reflection of a single polarization state over a target angle and wavelength range.

14. The backlight according to claim 13, wherein each of the first part and the second part is rendered anisotropic by an applied stretch, and the first and second parts are arranged such that a stretch direction of the first part is orthogonal to a stretch direction of the second part.

15. The backlight according to claim 1, wherein the first multilayer birefringent polymeric film comprises more than two different types of polymers.

16. A display device, comprising:
a liquid crystal panel; and
the backlight according to claim 1.

17. The display device according to claim 16, wherein the display device is a monochrome display device or a phosphor luminescent display.
